(19) United States
(12) Patent Application Publication
(10) Pub. No.: US 2013/0216667 A1
(43) Pub. Date: Aug. 22, 2013

(54) SALT COMPOSITION

(71) Applicants: Gideon Rath, Darmstadt (DE); Rainer Schnee, Mainz (DE)

(72) Inventors: Gideon Rath, Darmstadt (DE); Rainer Schnee, Mainz (DE)

(73) Assignee: CHEMISCHE FABRIK BUDENHEIM KG, Budenheim (DE)

(21) Appl. No.: 13/824,195

(22) PCT Filed: Sep. 22, 2011
(86) PCT No.: PCT/EP2011/066546

§ 371 Date: May 6, 2013

(30) Foreign Application Priority Data
Sep. 24, 2010 (DE) 10 2010 041 385.2

(51) Int. Cl. A23L 1/237

(52) U.S. Cl. CPC A23L 1/237
USPC 426/289; 426/649

(57) ABSTRACT

Salt substitute, in particular granular, crystalline or pulverulent and preferably for use as garnish salt or salt substitute, which contains

30 to 90 wt % sodium chloride or a mixture of sodium chloride and potassium chloride in a weight ratio of 1:2 to 2:1,
10 to 70 wt % of a combination of at least one carbon dioxide carrier and at least one acid carrier and
optionally up to 20 wt % of further additives,
wherein the carbon dioxide carrier is selected from sodium carbonate, sodium hydrogen carbonate, potassium carbonate (potash), potassium hydrogen carbonate, magnesium carbonate, magnesium hydrogen carbonate, calcium carbonate, calcium hydrogen carbonate, aluminium carbonate, aluminium hydrogen carbonate, ammonium carbonate, ammonium hydrogen carbonate, ammonium carbamate, hartshorn salt and mixtures of the above and
the at least one acid carrier is selected from sodium acid pyrophosphate (SAPP), monocalcium phosphate monohydrate (MCPM), anhydrous monocalcium phosphate (AMCP), all further hyd rates of monocalcium phosphate, d icalcium p hosphate dihydrate (DCPD), all further hydrates of dicalcium phosphate, sodium aluminium sulphate (SAS), sodium aluminium phosphate (SALP), calcium magnesium aluminium phosphate, calcium polyphosphate, calcium pyrophosphate, magnesium polyphosphate, magnesium pyrophosphate, calcium hydrogen phosphate, citric acid, fumaric acid, aspartic acid, tartaric acid, cream of tartar (potassium hydrogen tartrate), glucono-delta-lactone (GDL), sodium hydrogen citrate, lactic acid and mixtures of the above.

### SUBJECT OF THE INVENTION

The invention relates to a salt substitute, which is in particular in granular, crystalline or pulverulent form and can be used as garnish salt or dry salt substitute. The invention further relates to the use of the salt substitute and the production thereof.

### BACKGROUND OF THE INVENTION

The link between high salt consumption and high blood pressure and secondary diseases resulting therefrom has often been described and is known. The sodium content in common salt is considered to be the cause of high blood pressure. Industrially processed foodstuffs, such as bread and meat products, make the largest contribution to the daily consumption of salt. Therefore the relevant manufacturers are intensively researching how to reduce the sodium level in individual products, in order to lower the overall consumption for the benefit of the nation's health. Moreover, legal upper limits for the salt content of foodstuffs have already been established in some countries, so that there is also a demand for solutions for salt reduction for regulatory reasons.

There are various approaches for salt reduction. The three functions or effects of salt must be taken into account: taste, functionality and preservation. Many salt substitutes, which are intended to replace salt functionally, differ perceptibly in taste from common salt.

The term “salt substitute” used in connection with the present application denotes a substance or a composition of substances that either contains no sodium or, as is generally the case, has a greatly reduced sodium content relative to pure common salt or rock salt and nevertheless represents a substitute for common salt or rock salt with respect to one or more of the three a forementioned functions or effects of salt, namely taste, functionality and preservation. Most salt substitutes have a reduced portion of NaCl, which is replaced with a portion of other substances.

In one approach to the production of salt substitutes, the portion of NaCl is replaced at least partially with a portion of KCI, but in terms of taste this is described as metallic or bitter-tasting. This gustatory difference limits the use of these salt substitutes as pure salts, e.g. as garnish salt. They require a food matrix, which masks the difference in taste and acts as a diluent.

Other salt substitutes are intended to replace common salt or rock salt mainly with respect to taste, rather than functionally. These are for example systems based on yeast extract or other protein hydrolysates. Examples of compositions are described in WO 2007/132123. These salt substitutes cannot be used as table salt or garnish salt, because they are not white and do not have the appropriate grain size.

A further approach to salt reduction is based on particular mineral salts, which have a reduced portion of NaCl, which is replaced with a high content of minerals and other additional substances. Further examples of salt substitutes are disclosed in WO-A-2007/118566, EP-A-2 030 513 and U.S. Pat. No. 4,938,980.

In one application of salt, salts are added dry to foodstuffs and are only moistened in the mouth; these are called dry salts herein. These salts also often serve for decorative purposes and are known as garnish salt, pretzel salt, large-grained salt or coarse salt. Garnish salts are used inter alia on salty baked goods, such as baked goods dipped in lye, pretzels, salt sticks and snack products. The grain sizes of garnish salts typically have an edge length from 0.5 mm to 3 mm. A finer grain size from 0.5 mm to 1.6 mm is mainly used for sprinkling on baked products of industrial manufacture. Grain sizes with an edge length from 1 mm to 3 mm are used for sprinkling on baked goods dipped in lye, for example pretzels. Commercially available garnish salts consist either of compacted evaporated salt from the corresponding portion of rock salts. However, dry salts are also used as constituents of spice mixtures, which are e.g. sprinkled on snack products.

Reducing the sodium content in these dry salts, in particular in garnish salts, is a particular challenge in the production of salt substitutes, as they are intended to be white like common salt or rock salt and visually must have a coarse structure. The impression on chewing is also important. The granular salt substitute is not intended to crumble on chewing, but should disintegrate with a crack. However, the greatest difficulty arises in creating a typical salt taste of the salt substitutes. As garnish salt and other dry salts as a rule come in direct contact with the tongue, the taste should be purely typical of salt, as differences are not masked by a surrounding food matrix. Salt substitutes currently available do not offer the visual appearance of large-grained salt or have sensorially perceptible differences.

### OBJECT OF THE INVENTION

The object of the present invention was to provide a salt substitute, with improved properties with respect to taste and functionality relative to known salt substitutes, which in particular has a white appearance, is very similar in taste and with respect to mouthfeel and impression on chewing to common salt or rock salt and at the same time has a greatly reduced proportion of sodium compared to common salt or rock salt.

### DESCRIPTION OF THE INVENTION

The invention provides a salt substitute, in particular granular, crystalline or pulverulent and preferably for use as garnish salt or salt substitute, which contains 30 to 90 wt % sodium chloride, 10 to 70 wt % of a combination of at least one carbon dioxide carrier and at least one acid carrier and optionally up to 20 wt % of further additives, wherein the carbon dioxide carrier is selected from carbonates, hydrogen carbonates and carbamates of alkali metals, of alkaline-earth metals, of aluminium, of transition metals and/or of ammonium and mixtures thereof. Instead o f 30 to 90 wt % s odium chloride, the salt substitute according to the invention can also contain 30 to 90 wt % of a mixture of sodium chloride and potassium chloride in a weight ratio of 1:2 to 2:1, wherein the content of potassium chloride is expediently to be selected in such a way that the salt substitute does not have the metallic or bitter taste typical of potassium chloride. The proportion of potassium chloride still acceptable in gustatory terms will also depend in each case on the use of the salt substitute.

In the combination of at least one carbon dioxide carrier and at least one acid carrier, the ratio of carbon dioxide carriers to acid carriers expediently corresponds to the neutralization value of the carbon dioxide carriers and acid carriers used ±25%, preferably ±15%. The neutralization value indicates how much acid carrier is required for neutralizing a specific carbon dioxide carrier. It is found by dividing the amount of carbon dioxide carrier by the amount of acid carrier, needed for neutralizing the carbon dioxide carrier, and multiplying the quotient obtained by 100.

It was found, surprisingly, that a composition according to the invention with greatly reduced sodium chloride content is perceived as just as or at least almost as salty as pure sodium chloride. It was also surprising that with the salt substitute according to the invention, by compacting it is possible to produce grains or granules that produce a mouthfeel and an impression on chewing like coarse garnish salt. These grains or granules also withstand a usual baking process without visible change. Moreover, the salt substitute according to the invention can be produced with a white appearance, so that visually it also corresponds to or at least comes very close to common salt or rock salt. At the same time, the salt substitute according to the invention has a content of sodium chloride of only 30 to 90 wt % and thus a greatly reduced sodium level compared to common salt or rock salt.

In one embodiment the salt substitute according to the invention even has only 35 to 80 wt % sodium chloride, preferably 40 to 70 wt % sodium chloride, particularly preferably 45 to 60 wt % sodium chloride. In a quite particularly preferred embodiment the salt substitute according to the invention contains approximately 50 wt % sodium chloride. When the content of sodium chloride in the salt substitute according to the invention is stated in the description or the claims, this is also correspondingly intended to comprise embodiments with a mixture of sodium chloride and potassium chloride in place of sodium chloride in a weight ratio of 1:2 to 2:1. With proper use of the salt substitute according to the invention, thus up to a half or more of the amount of sodium chloride otherwise consumed with conventional salt can be saved and this will thus contribute to prevention of the known harmful consequences for health. At the same time, depending on the application, no or almost no impairment of the gustatory and functional properties of the salt substitute according to the invention is perceived, compared to conventional salt.

The at least one carbon dioxide carrier of the salt substitute according to the invention is preferably selected from sodium carbonate, sodium hydrogen carbonate (NaHCO₃), potassium carbonate (potash), potassium hydrogen carbonate (KHCO₃), magnesium carbonate, magnesium hydrogen carbonate, calcium carbonate, calcium hydrogen carbonate, aluminium carbonate, aluminium hydrogen carbonate, ammonium carbonate, ammonium hydrogen carbonate, ammonium carbamate, hartshorn salt and mixtures of the above. The carbon dioxide carrier sodium hydrogen carbonate (NaHCO₃) or potassium hydrogen carbonate (KHCO₃) is particularly preferred.

The at least one acid carrier of the salt substitute according to the invention is preferably selected from phosphates, condensed phosphates, phosphonates, phosphites, mixed hydroxide-phosphates, sulphates and cyanurates and organic acids.

Particularly suitable acid carriers of the salt substitute according to the invention are selected from sodium acid pyrophosphate (SAPP), monocalcium phosphate monohydrate (MCPM), anhydrous monocalcium phosphate (AMCP), all further hydrates of monocalcium phosphate, dicalcium phosphate dihydrate (DCPD), all further hydrates of dicalcium phosphate, sodium aluminium sulphate (SAS), sodium aluminium phosphate (SALP), calcium magnesium aluminium phosphate, calcium polyphosphate, calcium pyrophosphate, magnesium polyphosphate, magnesium pyrophosphate, calcium hydrogen phosphate, citric acid, fumaric acid, aspartic acid, tartaric acid, cream of tartar (potassium hydrogen tartrate), glucono-delta-lactone (GDL), sodium hydrogen citrate, lactic acid and mixtures of the above.

In a preferred embodiment the acid carrier is monocalcium phosphate monohydrate (MCPM). In a particularly preferred embodiment of the salt substitute according to the invention the carbon dioxide carrier is sodium hydrogen carbonate (NaHCO₃) and the a cid carrier is monocalcium phosphate monohydrate (MCPM). A particularly suitable salt substitute according to the invention contains for example 50 wt % sodium chloride, 27 wt % sodium hydrogen carbonate and 23 wt % monocalcium phosphate monohydrate (MCPM).

Advantageously, the salt substitute according to the invention contains 20 to 65 wt % of the combination of at least one carbon dioxide carrier and at least one acid carrier. The salt substitute according to the invention preferably contains 30 to 60 wt % or 40 to 55 wt % of the combination of at least one carbon dioxide carrier and at least one acid carrier. An amount of approximately 50 wt % of the combination of at least one carbon dioxide carrier and at least one acid carrier is particularly preferred.

Even the use of sodium compounds both as acid carrier and as carbon dioxide carrier on grounds of taste, costs or availability leads to a reduction of the sodium content in the salt substitute according to the invention relative to pure sodium chloride. Thus, for example even the combination of sodium hydrogen carbonate and sodium acid pyrophosphate (SAPP), which is unfavourable from the standpoint of the sodium content, contains approximately 41 wt % less sodium than NaCl. When mixed with for example 50% NaCl, this still means a reduction of the sodium content by 20% relative to pure sodium chloride.

The salt substitute according to the invention can consist exclusively of sodium chloride or mixture of sodium chloride and potassium chloride, carbon dioxide carrier and acid carrier. It can, however, also contain up to 20 wt % of further additives, which are preferably selected from binders, adhesives, compression aids, anti-caking agents, colorants, food dyes, fillers, maltodextrin, flavouring materials, herbs, herb substitutes, separating agents for preventing or delaying reaction between carbon dioxide carrier and acid carrier, cereal starch, maize starch, rice starch, wheat starch, modified flours, silicon dioxides, pyrogenic silicic acid, hydrophobic silicic acid, hydrophilic silicic acid, tricalcium phosphates, calcium carbonate, calcium sulphate, potassium chloride, silanes, fats and mixtures and combinations of the above.

With the additives, the salt substitute can be endowed with the most varied properties, which can either contribute to the gustatory or functional approximation of the salt substitute to “real” salt or can endow the salt substitute with particular properties, which pure common salt or rock salt do not possess. For example, dyes can be added, to produce coloured garnish salt.

The salt substitute according to the invention can be produced in any usual form for salt, such as granular, crystalline, pulverulent or also in large pieces or blocks. The salt substitute according to the invention is preferably in the form of granules. It is then free-flowing and can be used in a salt shaker or in coarse grain size as garnish salt.

The invention also comprises the use of the salt substitute according to the invention described herein as salt substitute or garnish salt on baked products, pastries, snack products, articles made with yeast and baked goods dipped in lye.

Moreover, the invention also comprises the production of the salt substitute according to the invention described herein, wherein the ingredients of the composition are first mixed and then ground or first ground and then mixed and then compacted to form grains.

Further advantages, features and embodiments of the present invention are explained by the examples described below.

### EXAMPLES

### Example 1

### Production of Salt Substitute Granules

For production of a salt substitute according to the invention from 50 wt % (5 kg) sodium chloride, 22 wt % (2.2 kg) sodium bicarbonate and 28 wt % (2.8 kg) calcium dihydrogen phosphate, the coarse components sodium chloride and sodium bicarbonate were first preground in a hammer mill and then mixed with the already somewhat finer calcium dihydrogen phosphate in a laboratory mixer. Then the mixture was compacted in a Hosokawa CS 25 compactor and pressed to form shells. The preset pressing force was 9.5 N/mm² and this produced shells that were mechanically stable immediately. The shells were then comminuted in a sieving mill and sieved at a sieve mesh size of 2 mm and 1 mm. In the sieving mill the rotor rotates at approx. 1-3 m/s and the material is passed gently through the mesh of the sieve. In the target fraction with a sieve mesh size of 1-2 mm, a yield of 35% was achieved.

### Example 2

### Production of Salt Substitutes According to the Invention and Comparative Compositions

The salt substitutes according to the present invention and comparative compositions presented in the table below were produced and were compared with pure common salt in a sensory test.

For production of the compositions according to the invention, the common salt was first ground in a mortar, until differences in grain size were no longer discernible. Then the nominal parts by weight of the respective ingredients were mixed mechanically.

TABLE 1
Salt substitutes according to the
invention and comparative examples

| | NaCl | Carbon dioxide | Acid carrier |
|---|---|---|---|
| No. | [wt %] | carrier [wt %] | [wt %] |
| 1 (invent.) | 50% | 22% NaHCO₃ | 28% MCPM |
| 2 (invent.) | 40% | 27% NaHCO₃ | 33% MCPM |
| 3 (comp.) | 50% | 50% TCP | — |
| 4 (comp.) | 50% | 50% maltodextrin | — |

invent. = example according to the invention
comp. = comparative example
TCP = tricalcium phosphate
Compared to pure sodium chloride, the sodium content of mixture No. 1 is reduced by 33%.

Sensory test

Each of the compositions produced was tasted in the triangle test, in each case in comparison with pure common salt. In each case approximately 50 mg of sample was put on a watch glass and two identical samples and a sample different from them were presented to the tasters in a triangular set-up. This procedure was repeated, so that first two samples of pure common salt and an example composition and then a sample of pure common salt and two samples of the example composition were presented. The tasters were asked which samples tasted like real salt and which were different. Altogether, the triangle test was carried out with each example composition with at least eight tasters. The results are presented in the following Table 2.

TABLE 2
Results of the sensory test

| | Differences from common | Differences from common |
|---|---|---|
| No. | salt not recognized [tasters] | salt recognized [tasters] |
| 1 | 75% | 25% |
| 2 | 50% | 50% |
| 3 | 40% | 60% |
| 4 | 33% | 67% |
| 5 | 40% | 60% |
| 6 | 40% | 60% |

Conclusion: The salt substitutes according to the invention are very similar in taste to pure common salt and are barely distinguishable in the sensory test. Compared to pure salt, the salt substitutes according to the invention have a clearly reduced sodium content.

Mixtures of sodium chloride with for example TCP are perceived on the basis of mouthfeel as different and sandy. Mixtures with maltodextrin (dextrose) produce a rather lumpy mouthfeel, which is untypical of salt. The salt substitutes according to the invention have a largely authentic salt taste and a mouthfeel typical of salt and can be processed to form a granular and free-flowing product.

1. A salt substitute, in particular granular, crystalline or pulverulent and preferably for use as garnish salt or salt substitute, which contains 30 to 90 wt % sodium chloride or a mixture of sodium chloride and potassium chloride in a weight ratio of 1:2 to 2:1,
10 to 70 wt % of a combination of at least one carbon dioxide carrier and at least one acid carrier and
optionally up to 20 wt % of further additives,
wherein the carbon dioxide carrier is selected from sodium carbonate, sodium hydrogen carbonate, potassium carbonate (potash), potassium hydrogen carbonate, magnesium carbonate, magnesium hydrogen carbonate, calcium carbonate, calcium hydrogen carbonate, aluminium carbonate, aluminium hydrogen carbonate, ammonium carbonate, ammonium hydrogen carbonate, ammonium carbamate, hartshorn salt and mixtures of the above and
the at least one acid carrier is selected from sodium acid pyrophosphate (SAPP), monocalcium phosphate monohydrate (MCPM), anhydrous monocalcium phosphate (AMCP), all further hydrates of monocalcium phosphate, dicalcium phosphate dihydrate (DCPD), all further hydrates of dicalcium phosphate, sodium aluminium sulphate (SAS), sodium aluminium phosphate (SALP), calcium magnesium aluminium phosphate, calcium polyphosphate, calcium pyrophosphate, magnesium polyphosphate, magnesium pyrophosphate, calcium hydrogen phosphate, citric acid, fumaric acid, aspartic acid, tartaric acid, cream of tartar (potassium hydrogen tartrate), glucono-delta-lactone (GDL), sodium hydrogen citrate, lactic acid and mixtures of the above.

2. The salt substitute according to claim 1, wherein, in the combination of at least one carbon dioxide carrier and at least one acid carrier, the ratio of carbon dioxide carriers to acid carriers corresponds to the neutralization value of the carbon dioxide carrier and acid carrier used ±25%, preferably ±15%.

3. The salt substitute according to claim 1, wherein the at least one carbon dioxide carrier is sodium hydrogen carbonate, potassium hydrogen carbonate or a mixture thereof.

4. The salt substitute according to claim 1, wherein the at least one acid carrier is monocalcium phosphate monohydrate (MCPM).

5. The salt substitute according to claim 1, wherein it contains 35 to 80 wt % sodium chloride, preferably 40 to 70 wt % sodium chloride, particularly preferably 45 to 60 wt % sodium chloride, quite particularly preferably approximately 50 wt % sodium chloride.

6. The salt substitute according to claim 1, wherein it contains 20 to 65 wt % of the combination of at least one carbon dioxide carrier and at least one acid carrier, preferably 30 to 60 wt % of the combination of at least one carbon dioxide carrier and at least one acid carrier, particularly preferably 40 to 55 wt % of the combination of at least one carbon dioxide carrier and at least one acid carrier, quite particularly preferably approximately 50 wt % of the combination of at least one carbon dioxide carrier and at least one acid carrier.

7. The salt substitute according to claim 1, wherein the further additives are selected from binders, adhesives, compression aids, anticaking agent, colorants, food dyes, fillers, maltodextrin, flavouring materials, herbs, herb substitutes, separating agents for preventing or delaying reaction between carbon dioxide carrier and acid carrier, cereal starch, maize starch, rice starch, wheat starch, modified flours, silicon dioxides, pyrogenic silicic acid, hydrophobic silicic acid, hydrophilic silicic acid, tricalcium phosphates, calcium carbonate, calcium sulphate, potassium chloride, silanes, fats and mixtures and combinations of the above.

8. The salt substitute according to claim 1, wherein it is produced in the form of grains or granules.

9. A method of using a salt substitute comprising applying the salt substitute according to claim 1 as a salt substitute or garnish salt on baked products, pastries, snack products, articles made with yeast and baked goods dipped in lye.

10. A method for producing the salt substitute according to claim 1, in which the ingredients of the composition are first mixed and then ground or are first ground and then mixed and then compressed to form grains or granules.
